(19) United States
(12) Patent Application Publication
(10) Pub. No.: US 2022/0296046 A1
(43) Pub. Date: Sep. 22, 2022

(54) Inverted Suspension Poultry Roasting Rack

(71) Applicant: Francis D. O'Dea, Arlington, VA (US)

(72) Inventors: Francis D. O'Dea, Arlington, VA (US); Glen L. Archer, III, Alexandria, VA (US); Kevin G. Williams, Park City, UT (US)

(21) Appl. No.: 17/204,598

(22) Filed: Mar. 17, 2021

(51) Int. Cl. A47J 43/18

(52) U.S. Cl. CPC A47J 43/18

(57) ABSTRACT

An improved inverted suspension poultry roasting rack for supporting and suspending a poultry in an inverted and downwardly-angled orientation with only the interior of the poultry making physical contact with the support rack. The improved inverted suspension poultry roasting rack generally includes a base permanently connected to a pan, pan insert, or free-standing base, a poultry support comprising a first member adapted to removably slidably attach to the base, a second member extending upwardly from the first member at a first angle, a third member extending downwardly from the second member, and a fourth member comprising a retention structure extending upwardly from the third member at a third angle. The poultry is positioned on the third member and retained in an inverted and downwardly-angled orientation for cooking by the fourth member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to an inverted suspension poultry roasting rack for cooking poultry and more specifically for supporting and suspending a poultry in an inverted and downwardly-angled orientation for cooking with only the interior portion of the poultry making physical contact with the support rack.

### Related Art

Any discussion of the related art throughout the specification should in no way be considered as an admission that such related art is widely known or forms part of common general knowledge in the field.

Conventional poultry racks generally support the poultry (e.g., chicken, duck, game hen, goose, etc.) in a vertical or horizontal manner. In addition, conventional poultry racks typically make physical contact with the exterior surface of the poultry during cooking which can result in uneven cooking and burning in locations.

One inverted suspension poultry roasting rack supports and suspends the poultry in an inverted orientation with the rack making physical contact only with the interior portion of the poultry. While this inverted suspension poultry roasting rack functions well, additional structural improvements are possible.

There is thus a need for a new and improved inverted suspension poultry roasting rack for supporting and suspending a poultry in an inverted position with the roasting rack making physical contact only with the interior portion of the poultry.

### SUMMARY

An example embodiment is directed to an inverted suspension poultry roasting rack. The inverted suspension poultry roasting rack may include a pan, a pan insert adapted to be received and supported in or on the pan, or a free-standing base structure, a base connected to a surface of the pan, pan insert, or free-standing base structure, and a poultry support that is removably connectable to the base. The poultry support is adapted to support and suspend a poultry having an interior and an exterior in an inverted and downwardly-angled orientation above the surface of the pan or pan insert or an open space of the free-standing base structure for cooking with the poultry support having substantial physical contact only with the interior of the poultry.

According to one aspect, the base may be permanently and non-movably connected to the surface, may comprise a receiver adapted to slidably receive and retain the poultry support, and may comprise an anti-rotation mechanism adapted to engage the poultry support and prevent it from rotatably moving relative to the base.

According to another aspect, the poultry support may be comprised of a single elongated metal rod and may comprise a first member removably connectable to the base, a second member extending upwardly from the first member at a first angle with respect to the surface, a third member extending downwardly from the second member at a second angle with respect to the surface, and a fourth member extending upwardly from the third member at a third angle with respect to the surface. The third member is adapted to support and suspend the poultry and the fourth member is adapted to prevent the poultry from sliding off the third member.

There has thus been outlined, rather broadly, some of the embodiments of the inverted suspension poultry roasting rack in order that the detailed description thereof may be better understood, and in order that the present contribution to the art may be better appreciated. There are additional embodiments of the inverted suspension poultry roasting rack that will be described hereinafter and that will form the subject matter of the claims appended hereto. In this respect, before explaining at least one embodiment of the inverted suspension poultry roasting rack in detail, it is to be understood that the inverted suspension poultry roasting rack is not limited in its application to the details of construction or to the arrangements of the components set forth in the following description or illustrated in the drawings. The inverted suspension poultry roasting rack is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a top exploded perspective view of an inverted suspension poultry roasting rack in accordance with an example embodiment.

FIG. 2A is a top perspective view of an inverted suspension poultry roasting rack with a poultry support aligned for insertion in a base in accordance with an example embodiment.

FIG. 2B is a top perspective view of an inverted suspension poultry roasting rack with a poultry support inserted in a base in accordance with an example embodiment.

FIG. 3 is a top view of an inverted suspension poultry roasting rack with a poultry support inserted in a base in accordance with an example embodiment.

FIG. 4 is a side view of an inverted suspension poultry roasting rack with a poultry support inserted in a base in accordance with an example embodiment.

FIG. 5A is an enlarged top perspective view of a base of an inverted suspension poultry roasting rack in accordance with an example embodiment with a first member of a poultry support inserted in a receiver of the base.

FIG. 5B is an enlarged view of a first end of a base of an inverted suspension poultry roasting rack in accordance with an example embodiment.

FIG. 5C is an enlarged view of a second end of a base of an inverted suspension poultry roasting rack in accordance with an example embodiment.

FIG. 5D is a top view of an inverted suspension poultry roasting rack in a disassembled state in accordance with an example embodiment

FIG. 5E is an enlarged top perspective view of an alternative embodiment of a base of an inverted suspension poultry roasting rack in accordance with an example embodiment with a first member of a poultry support inserted in a receiver of the base.

FIG. 5F is an enlarged top perspective view of another alternative embodiment of a base of an inverted suspension poultry roasting rack in accordance with an example embodiment with a first member of a poultry support inserted in a receiver of the base.

FIG. 6 is a side view of an inverted suspension poultry roasting rack in accordance with an example embodiment supporting a poultry in an inverted orientation with the breast facing downward and with the poultry illustrated in cutaway to reveal members of a poultry support.

FIG. 7 is a top exploded perspective view of an inverted suspension poultry roasting rack in accordance with a second example embodiment.

FIG. 8A is a top perspective view of an inverted suspension poultry roasting rack in accordance with a second example embodiment with a poultry support aligned for insertion in a base.

FIG. 8B is a top perspective view of an inverted suspension poultry roasting rack in accordance with an example embodiment with a poultry support inserted in a base.

FIG. 9 is a top view of an inverted suspension poultry roasting rack in accordance with a second example embodiment with a poultry support inserted in a base.

FIG. 10 is a side view of an inverted suspension poultry roasting rack with a poultry support inserted in a base in accordance with a second example embodiment.

FIG. 11A is an enlarged top perspective view of a base of an inverted suspension poultry roasting rack in accordance with a second example embodiment with first members of a poultry support inserted in corresponding receivers of the base.

FIG. 11B is an enlarged view of a first end of a base of an inverted suspension poultry roasting rack in accordance with a second example embodiment.

FIG. 11C is an enlarged view of a second end of a base of an inverted suspension poultry roasting rack in accordance with a second example embodiment.

FIG. 12 is a side view of an inverted suspension poultry roasting rack in accordance with a second example embodiment supporting a poultry in an inverted orientation with the breast facing downward and with the poultry illustrated in cutaway to reveal members of a poultry support.

FIG. 13 is a top perspective view of an inverted suspension poultry roasting rack in accordance with a third example embodiment.

FIG. 14 is a top view of an inverted suspension poultry roasting rack in accordance with a third example embodiment.

FIG. 15 is a side view of an inverted suspension poultry roasting rack in accordance with a third example embodiment supporting a poultry in an inverted orientation with the breast facing downward and with the poultry illustrated in cutaway to reveal members of a poultry support.

### DETAILED DESCRIPTION

### A. Overview.

Example embodiments of an inverted suspension poultry roasting rack 10 generally comprise a base 30 having one or more receivers 32, a poultry support 40, and a pan 18, pan insert 20, or free-standing base structure 90. The base 30 is permanently and non-movably attachable to a substantially horizontal upper surface of the pan 18, pan insert 20, or free-standing base structure 90. The pan insert 20 and the free-standing base 90 may be configured and adapted to be supported in or on the pan 18 or another cooking or drip collection item.

The poultry support 40 is removably and slidably connectable to the base 30 via the one or more receivers 32. With the poultry support 40 connected to the base 30, the poultry support 40 extends above the upper surface of the pan 18, pan insert 20, or free-standing base 90. The poultry support 40 is configured and adapted to support and suspend a poultry 12 for cooking in a preferred inverted and downwardly-angled orientation with the breast of the poultry at the lowest point and the legs at a higher point. The roasting rack 10 is not in physical contact with the exterior of the poultry 12 and the exterior surfaces of the poultry are not in physical contact with the pan 18, pan insert 20, or free-standing base structure 90.

The poultry support 40 may be comprised of a single elongated rod. The poultry support 40 comprises a first member 50, second member 60, third member 70, and fourth member 80. Each of the members comprises an elongated substantially linear structure. Each of the members may comprise a single structure, such as a single rod portion, or two or more corresponding and co-extensive structures such as two or more parallel rod portions.

The one or more receivers 32 of the base 30 are configured and adapted to removably slidably receive the first member 50 of the poultry support 40 and to retain the poultry support 40 in the position above the upper surface of the pan 18, pan insert 20, or stand-along base structure 90. The one or more receivers 32 comprise an anti-rotation mechanism that is adapted to engage the poultry support 40 and prevent it from rotatably moving relative to the base 30. The second member 60 extends upwardly from the first member 50 at a first angle relative to the upper surface. The third member 70 extends downwardly from the second member 60 at a second angle relative to the upper surface. The fourth member 80 comprises a retention structure and extends from the third member 70 upwardly at a third angle relative to the upper surface. The third member 70 supports and suspends the poultry 12 in the preferred inverted and downwardly-angled orientation and the fourth member 80 engages a neck opening of the poultry 12 to prevents the poultry 12 from sliding off the third member 70.

Cooking the poultry 12 in the preferred inverted and downwardly-angled orientation allows the breasts and legs of the poultry 12 to cook more evenly and maintains moistness in the breasts. The inverted suspension poultry roasting rack 10 not being in physical contact with the exterior surface of the poultry 12 also allows the exterior surface to cook evenly and in a crispy manner without burning.

### B. Poultry.

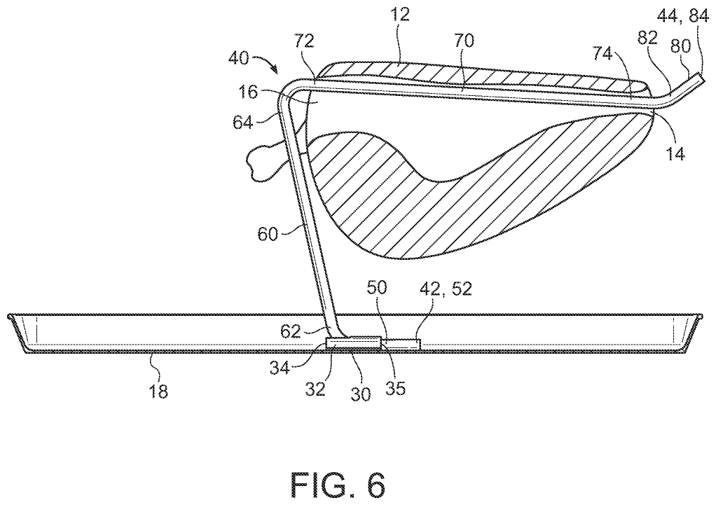

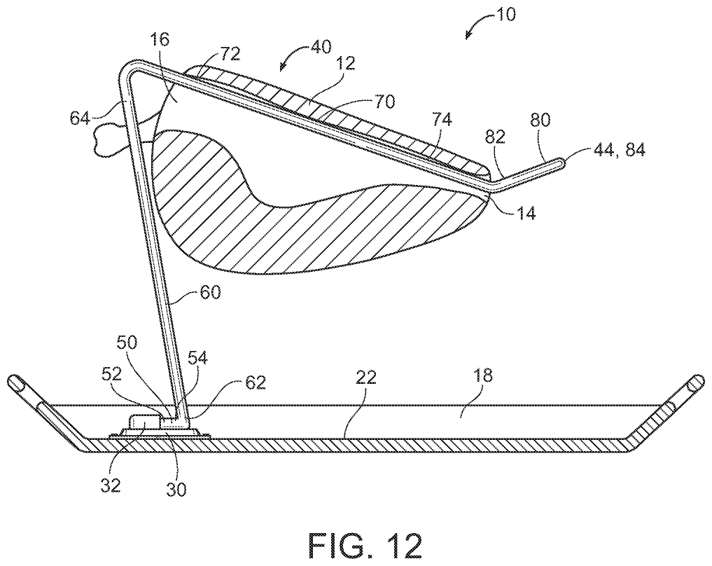

The example embodiments of the inverted suspension poultry roasting rack 10 are designed to receive, support, and suspend various types of poultry 12 (e.g. chicken, duck, game hens, goose, etc.). The poultry 12 can have a neck opening 14 and a rear opening 16 with an interior body cavity as best illustrated in FIGS. 6, 12, and 15. The example embodiments of the inverted suspension poultry roasting rack 10 are designed to receive, support, and suspend the poultry 12 in an inverted orientation with the breast portion of the poultry 12 being the lowest portion of the poultry 12 and with the legs supported at a higher level to allow for the poultry 12 to cook more evenly since the legs take longer to cook. This orientation also provides the benefit that the juices of the poultry 12 naturally flow via gravity toward the breast portion to maintain the moistness of the breast.

### C. Pan.

The example embodiments of the inverted suspension poultry roasting rack 10 may be connected or attached to and/or supported on or within a conventional oven rack or more preferably a pan 18 to catch any drippings. The pan 18 comprises an upper surface 19 that is suitable and adapted for attaching, connecting, and/or supporting the inverted suspension poultry roasting rack 10. Preferably, the surface 19 is a substantially horizontal flat planar surface. The pan 18 may be comprised of any type of flat cooking item such as but not limited to a sheet pan 18 or roasting pan 18.

### D. Pan Insert.

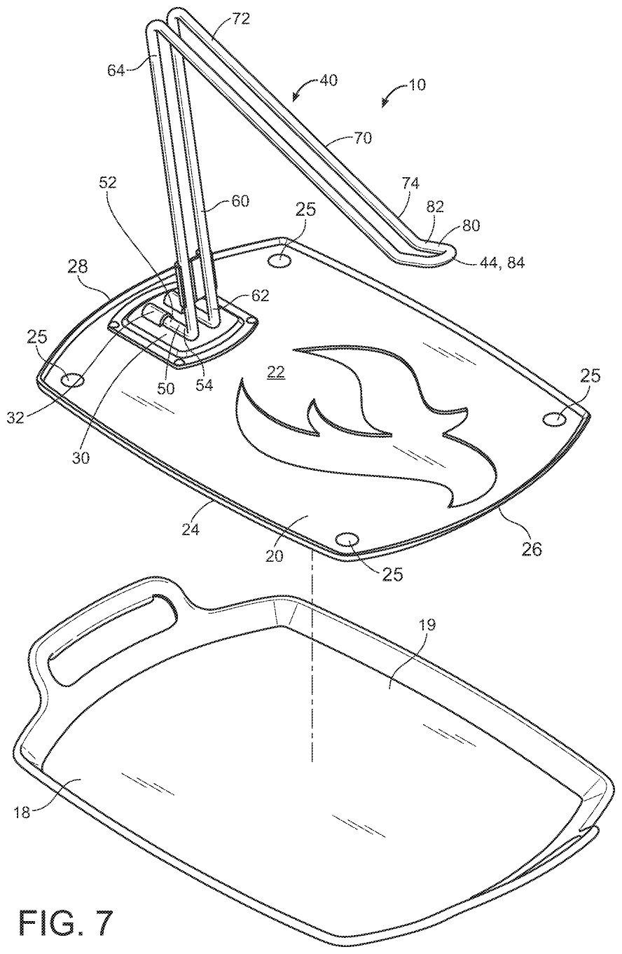

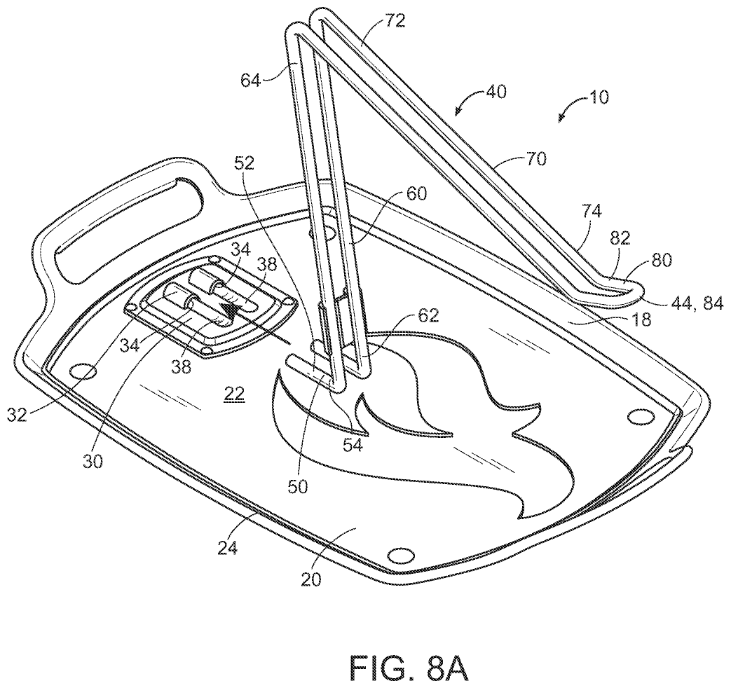

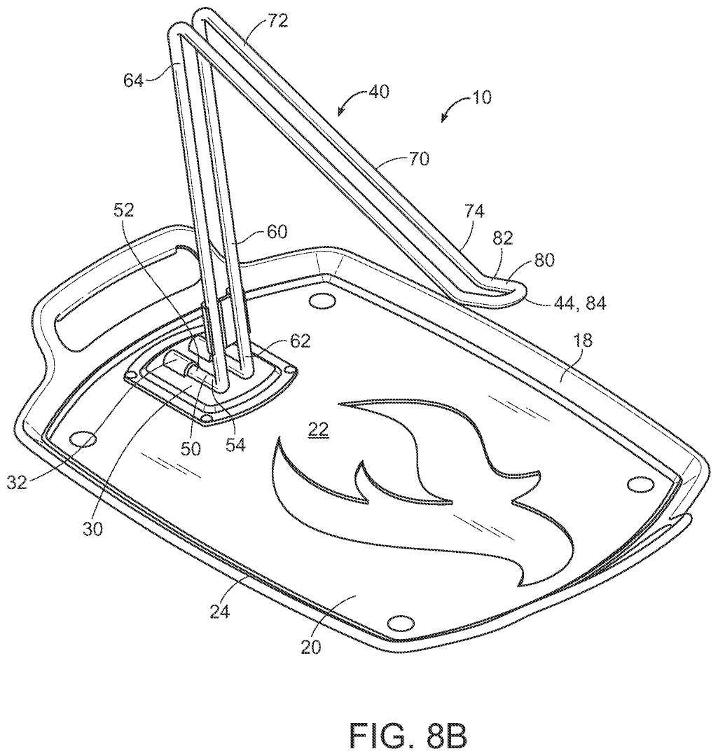

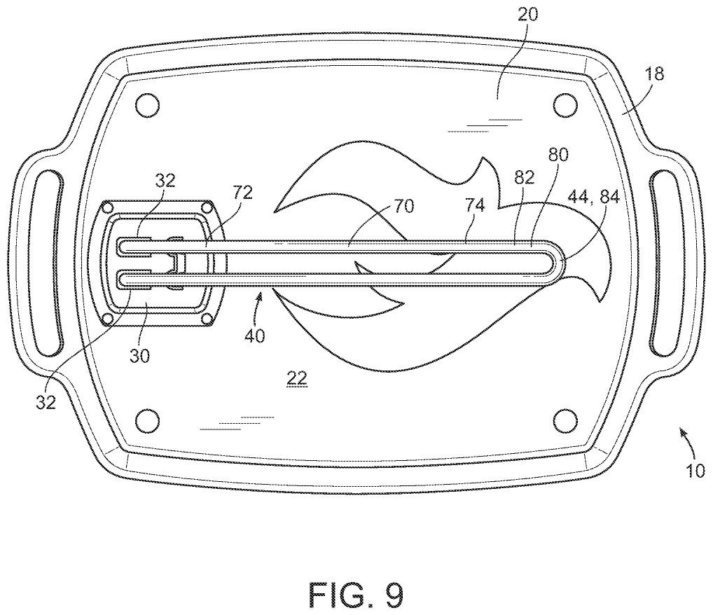

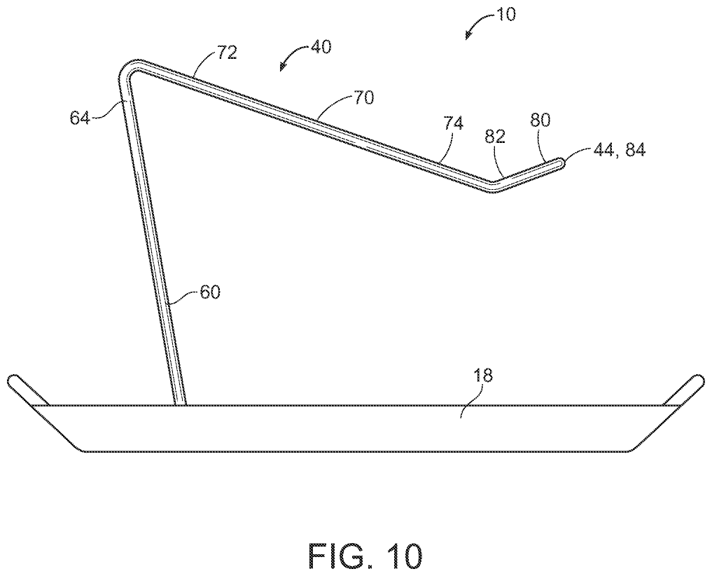

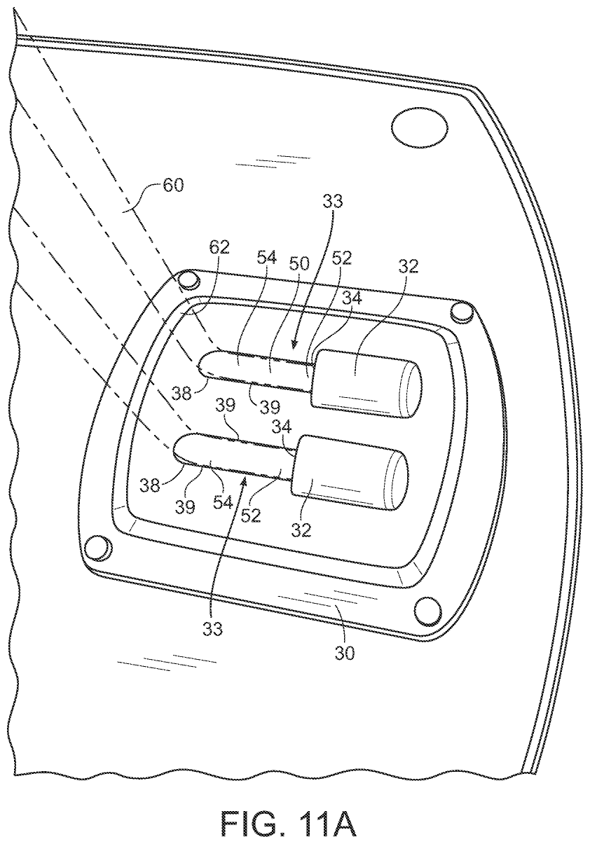

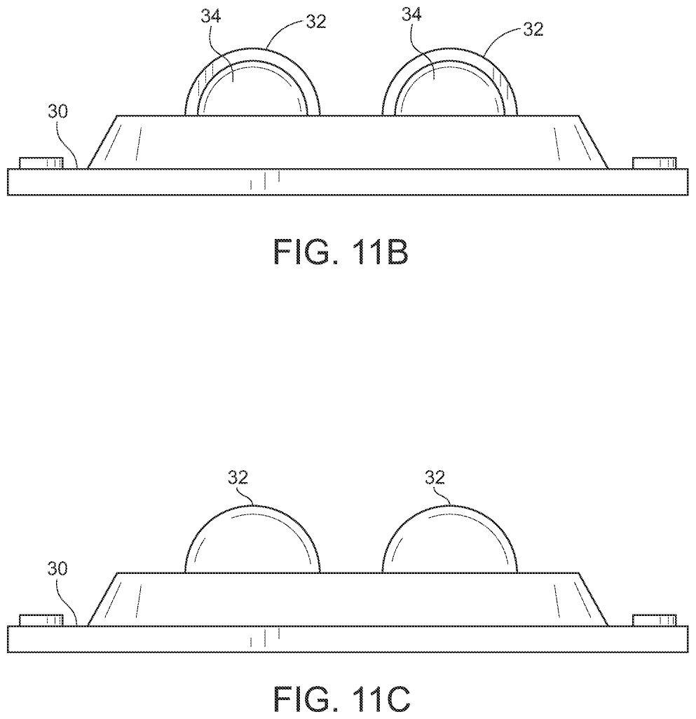

In one example embodiment illustrated in FIGS. 7-12 and as best illustrated in FIGS. 7-10, the inverted suspension poultry roasting rack 10 may comprise a pan insert 20. The pan insert 20 is preferably dimensioned, shaped and adapted to be removably received and supported in or on the pan 18. The pan insert 20 may comprise a substantially flat, planar structure with an upper surface 22, a lower surface 24, a first end 26, a second end 28 opposite the first end 26, and one or more stand-offs 25.

The pan insert 20 is adapted to be received and supported in or on the pan 18 with the lower surface 24 on or slightly above and adjacent to the upper surface 19 of the pan 18. The stand-offs 25 may extend outwardly from the lower surface 24 of the pan insert 20 and are adapted to make contact with the upper surface 19 of the pan 18 when the pan insert 20 is received and supported in or on the pan 18 so that there is a slight air gap between the pan 18 and the pan insert 20, and more specifically the upper surface 19 of the pan 18 and the lower surface 24 of the pan insert 20. The stand-offs 25 may be part of a single structure with the pan insert 20 or may be suitably attached or connected to the pan insert 20. As best illustrated in FIG. 7, the stand-offs 25 may comprise dimples, indents or other structures in the upper surface 22 of the pan insert 20 that extend as protrusions from the lower surface 24 of the pan insert 20. Alternatively, the stand-offs 25 can comprise protrusions or feet that extend outwardly from the lower surface 24 without any corresponding structure on the upper surface 22.

As described further below, the pan insert 20 is adapted for the poultry support 40 to be attached or connected via the base 30 so that for cooking purposes the poultry 12 is supported and suspended above the upper surface 22 of the pan insert 20 without any substantial physical contact between the exterior surface of the poultry 12 and the pan insert 20, and with the poultry support 40 in physical contact only with the interior of the poultry 12. However, because the pan insert 20 is receivable in or on the pan 18 and is selectively removable from the pan 18, it may also serve as a preparation surface for the poultry 12 before cooking begins and as a carving or post-cooking preparation surface for the poultry 12 once cooking is completed.

### E. Free-Standing Base Structure.

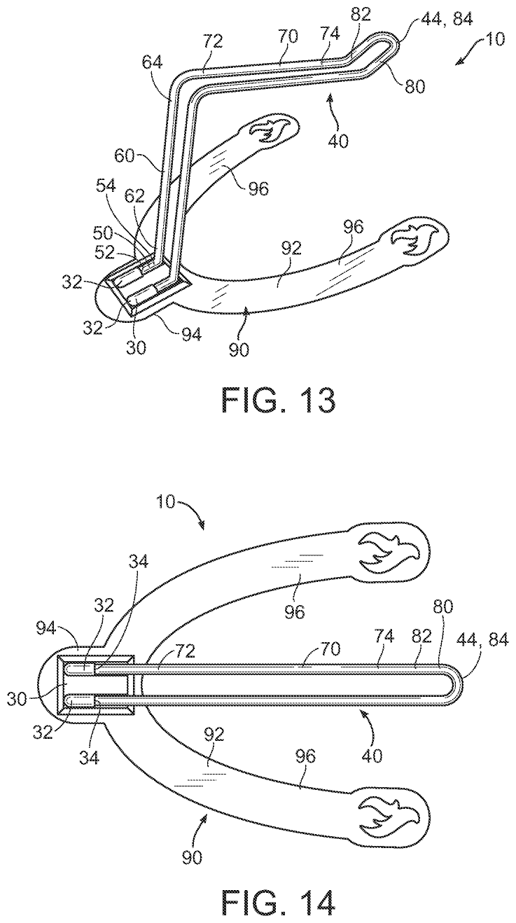

In another example embodiment illustrated in FIGS. 13-15, the inverted suspension poultry roasting rack 10 may comprise a free-standing base structure 90. The free-standing base structure 90 comprises a stable counter-weighted and counter-balanced structure that enables the poultry 12 to be suspended and supported on the poultry support 40 without the inverted suspension poultry roasting rack 10 being permanently attached or connected to the pan 18, pan insert 20, or an oven or other cooking device or structure. While the free-standing base structure 90 may be used alone and without the pan 18, pan insert 20, or similar cooking or drip collecting item, it is preferably dimensioned, shaped and adapted to be removably received and supported in or on the pan 18, pan insert 20, or or other cooking item, device, or structure to collect drippings from the poultry 12.

The free-standing base structure 90 may comprise a substantially flat structure with an upper surface 92, a common connection area 94, and a plurality of extensions 96. The plurality of extensions 96 may be relatively narrow and elongated with first ends and second ends opposite the first ends. The extensions 96 extend outwardly from the common connection area 94 in different directions and preferably have open space between them. The extensions 96 are configured and adapted to provide stability to the free-standing base structure 90. Consistent with that objective, the extensions 96 may comprise linear structures or curved structures, as illustrated in FIGS. 13-15. The extensions 96 also may be arranged in a variety of configurations, for example in a wish-bone-like shape as illustrated in FIGS. 13-15.

The entire free-standing base structure 90 may comprise a single structure. Alternatively, one or more of the extensions 96 and the common connection area 94 may comprise separate structures and extensions 96 may be connected or attached to the common connection area 94 at their respective first ends by suitable means. The free-standing base 90 preferably comprises a relatively strong and heavy material, such as a strong gauge cast iron. The weight of the free-standing base 90 provides counter-weight and counter-balance against the weight of the poultry 12 when supported and suspended on the poultry support 40.

### F. Base.

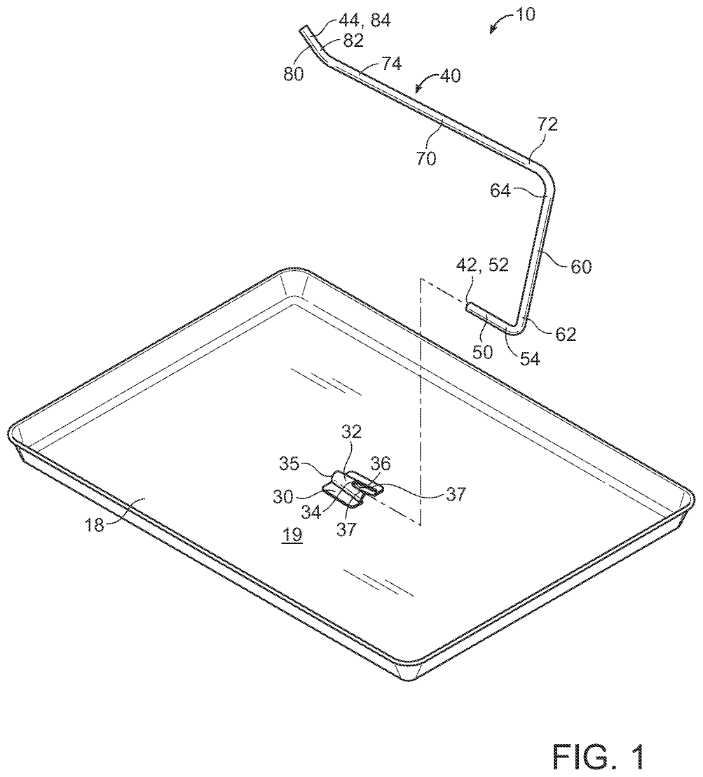

In one example embodiment illustrated in FIGS. 1-6, the base 30 is preferably permanently and non-movably connected or attached to the pan 18 and more particularly the upper surface 19 of the pan 18. In another example embodiment illustrated in FIGS. 7-12, the base 30 is preferably permanently and non-movably connected or attached to the pan insert 20 and more particularly the upper surface 22 of the pan insert 20. In yet another example embodiment illustrated in FIGS. 13-15, the base 30 is preferably permanently and non-movably connected or attached to the free-standing base structure 90 and more particularly the upper surface 92 of the common connection area 94 of the free-standing base structure 90. Alternatively, the base 30 can comprise part of the structure of the pan 18, pan insert 20, or free-standing base 90. The base 30 may be positioned at various locations on the upper surfaces 19, 22, and 92 of the pan 18, pan insert 20, or free-standing base structure 90 respectively depending on the particular configuration of the poultry support 40 as described further below.

In each example embodiment, the base 30 comprises one or more receivers 32. The receivers 32 are configured and adapted to removably attach or connect the poultry support 40 described in further detail below to the pan 18, pan insert 20, or free-standing base structure 90.

In the example embodiment illustrated in FIGS. 1-6, a single receiver 32 comprises an elongated hollow body having a first end with a first end opening 34 and a second end opposite the first end with a second end opening 35. The first end opening 34 is preferably configured and adapted to removably slidably receive a first end portion 52 of a first member 50 of the poultry support 40 substantially parallel with the upper surface 19 of the pan 18. The receiver 32 is configured and adapted for the first member 50 to slidably pass through and be retained at least partially in the hollow body with the first end portion 52 extending outwardly from the second end opening 35. As described further below, a second end portion 54 of the first member 50 is connected to and/or transitions into a first end portion 62 of a second member 60 of the poultry support 40. The receiver 32 is configured and adapted to permit the first member 50 to continue to be inserted through the first end opening 34 substantially parallel to the upper surface 19 and to slidably pass through the hollow body up to a point at or near the connection or transition between the first member 50 and the second member 60. At that point, as the connection, transition, or second member 60 begins to extend upwardly from the first member 50, the poultry support 40 comes into contact with a surface of the receiver 32 adjacent to the first end opening 34 which prevents further insertion of the first member 50.

In the example embodiments illustrated in FIGS. 7-12 and 13-15, the base 30 comprises two or more corresponding receivers 32. The two or more corresponding receivers 32 have elongated hollow bodies with first and second ends and receiver first end openings 34 that are configured and adapted to removably slidably receive corresponding first end portions 52 of corresponding elongated structures comprising the first member 50 of the poultry support 40. Preferably, but not necessarily, the receivers 32 are substantially identical and are parallel with each other or are otherwise arranged and oriented in the same manner as the corresponding elongated structures comprising the first member 50 to enable the first end portions 52 of the corresponding structures to be removably slidably inserted in the first end openings 34 and retained in the base 30.

Similar to the description above, the receivers 32 are configured and adapted to permit the first end portions 52 of the corresponding elongated structures comprising the first member 50 to be inserted through the first end openings 34 and to pass through the hollow bodies substantially parallel to the upper surface 22 or 92 and up to a point at or near the connection or transition between the first member 50 and the second member 60. At that point, as the connection, transition, or second member 60 begins to extend upwardly from the first member 50, the poultry support 40 comes into contact with surfaces of the receivers 32 adjacent to the first end openings 34 which prevent further insertion of the first member 50. The second ends of the hollow bodies may also be closed rather than have second end openings and may be adapted to contact the first end portions 52 of the corresponding elongated structures comprising the first member 50 and prevent further insertion of the first member 50 in the receivers 32.

The one or more receivers 32 are further configured and adapted for the first member 50 to be slidably removed from the one or more receivers 32 in order to disconnect or detach the poultry support 40 from the pan 18, for example to remove the poultry 12 following cooking, disassemble the inverted suspension poultry roasting rack 10, and/or to store the poultry support 40. This is accomplished by simply reversing the process of inserting the first member 50 of the poultry support 40 in the one or more receivers 32 as described above.

The one or more receivers 32 are also configured and adapted to retain the first member 50 of the poultry support 40 in a position with the poultry support 40 extending upwardly above the upper surface 19 of the pan 18, the upper surface 22 of the pan insert 20, or the upper surface 92 of the free-standing base structure 90. In this regard, the one or more receivers 32 of the base 30 may comprise anti-rotation mechanisms 33 to prevent the poultry support 40 from rotatably moving relative to the base 30 and hence the pan 18, pan insert 20, or free-standing base structure 90.

In the example embodiment illustrated in FIGS. 1-6, the anti-rotation mechanism 33 of the receiver 32 comprises a cut-out member 36 located adjacent to and atop the first end opening 34 and upwardly extending opposed side members 37 located laterally of the cut-out member 36 and the first end opening 34. The cut-out member 36 is preferably located in an upper surface of the hollow body of the receiver 32 adjacent to and atop the first end opening 34 and extends longitudinally along the direction of the elongated hollow body from the first end opening 34 toward the second end opening 35. The cut-out member 36 exposes the upwardly extending opposed side members 37 which preferably are located and extend laterally along opposite sides of the first end opening 34 and extend in an upward direction relative to the base 30. The cut-out member 36 enables the first member 50 to be inserted in the receiver 32 with the portion of the poultry support 40 where the transition or interconnection between the first member 50 and the second member 60 begins to extend upwardly from the base 30 between the opposed upwardly extending side members 37. The opposed upwardly extending side members 37 are configured and adapted to engage with the upwardly extending portion of the poultry support 40 at that location and thus prevent the poultry support 40 from rotatably moving relative to the receiver 32. Accordingly, with the poultry support 40 connected or attached to the base 30, the poultry 12 can be maintained in the preferred inverted and downwardly-angled orientation described herein for cooking.

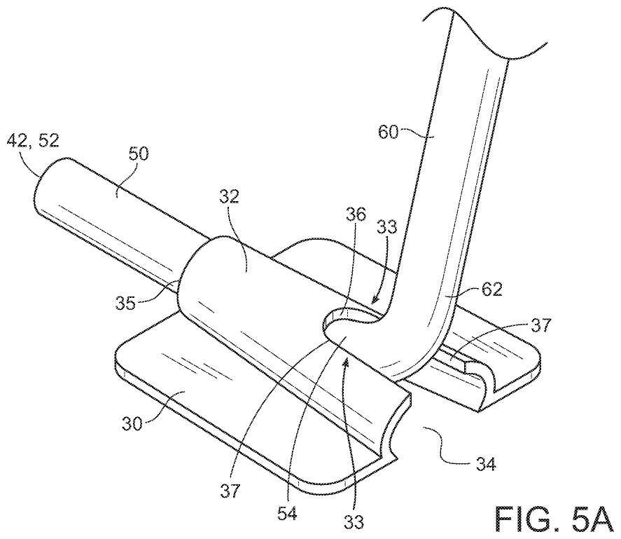

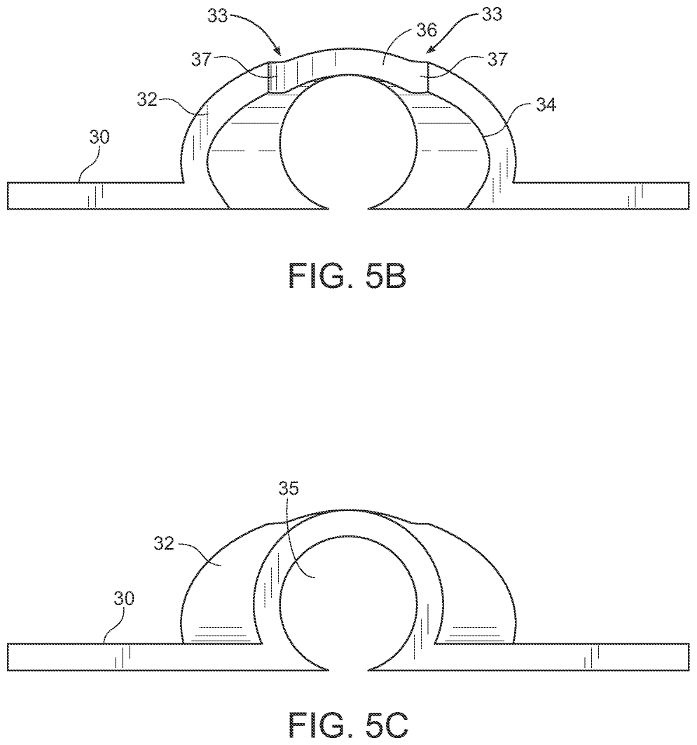

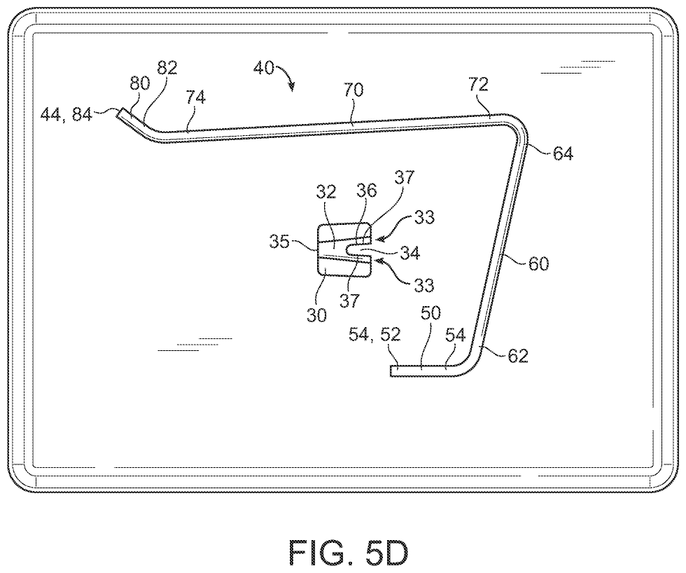

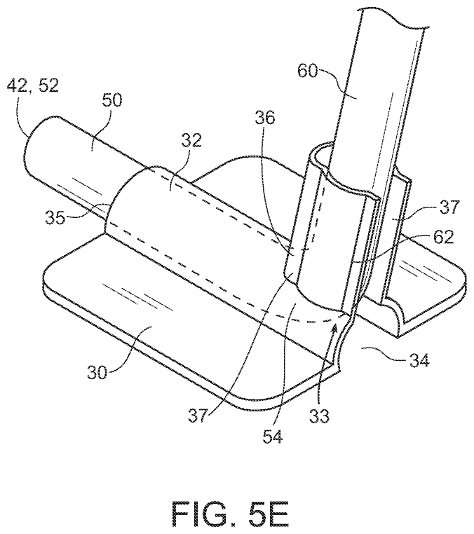

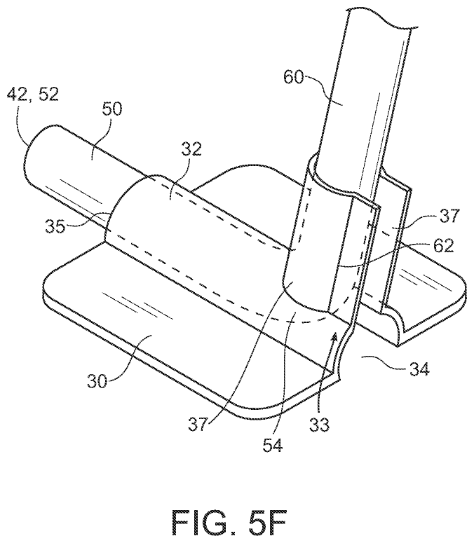

It will be appreciated that in some embodiments, such as illustrated in FIG. 5A and described above, the upwardly extending side members 37 may comprise just the opposed upwardly extending side surfaces exposed by the cut-out member 36. In other embodiments, the side members 37 may continue to extend upwardly from the opposed side surfaces exposed by the cut-out member 36 for a further distance above the base 30, as illustrated in FIGS. 5E and 5F. In such embodiments, the upwardly extending side members 37 may enclose and engage at least part of the first end portion 62 of the second member 60 in order to prevent the poultry support 40 from rotatably moving relative to the receiver 32. In addition, as shown in FIGS. 5E and 5F, the upwardly extending side members 37 may be configured to form a relatively narrower entrance portion for the first end portion 62 and a relatively wider main portion for retaining the first end portion 62 such that the first end portion 62 can be “snapped” into place between and within the upwardly extending side members 37. If desired, and as shown in FIG. 5E, a small space may be provided between the main portion adapted to retain the first end portion 62 and the end of the cut-out member 36 to enable the position of the poultry support 40 relative to the receiver 32 to be adjusted laterally by a small amount. Alternatively, as shown in FIG. 5F, the small space may be eliminated and the main portion adapted to retain the first end portion 62 may have substantially the same shape of the first end portion with side walls that at least partially surround, and are closely spaced and/or abut the sides of the first end portion 62 and prevent further lateral movement into the receiver 32.

In the example embodiments illustrated in FIGS. 7-12 and 13-15, the receivers 32 similarly comprise an anti-rotation mechanism 33 that is configured and adapted to engage with and prevent the poultry support 40 from rotatably moving with respect to the receivers 32 and the base 30. In these embodiments, the anti-rotation mechanism 33 comprises elongated inset slot members 38 and opposed upwardly extending side members 39. An elongated inset slot member 38 is positioned adjacent to and in alignment with the receiver first end opening 34 of each receiver 32. The slot members 38 are inset in the upper surfaces 22 of the pan insert 20 and 92 of the free-standing base structure 90 respectively. Each inset slot member 38 exposes a pair of opposed upwardly extending side members 39 each comprising an opposite lateral side surface of the slot member 38. The opposed side members 39 extend upwardly from the bottoms of the inset slot members 38 to the upper surfaces 22, 92 of the pan insert 20 and free-standing base structure 90 respectively.

The inset slots 38 are configured and adapted to slideably receive the corresponding elongated structures comprising the first member 50 of the poultry support 40 as they are slidably inserted into the first end openings 34 of the corresponding receivers 32. With the first member 50 fully inserted in the receivers 32, the portion of the poultry support 40 where the transition or interconnection between the first member 50 and the second member 60 begins to extend upwardly from the base 30 is between the upwardly extending opposed side members 39. The opposed upwardly extending side members 39 are configured and adapted to engage with the upwardly extending portion of the poultry support 40 at that location and thus prevent the poultry support 40 from rotatably moving relative to the receiver 32. Accordingly, with the poultry support 40 connected or attached to the base 30, the poultry 12 can be maintained in the preferred inverted and downwardly-angled orientation described herein for cooking.

### G. Poultry Support.

The poultry support 40 is adapted and configured to be removably attached or connected via the one or more receivers 32 of the base 30 to the pan 18 in the example embodiment illustrated in FIGS. 1-6, to the pan insert 20 in the example embodiment illustrated in FIGS. 7-12, and to the free-standing base structure 90 in the example embodiments illustrated in FIGS. 13-15. In each of the example embodiments, the poultry support 40 is adapted and configured to support and suspend the poultry 12 in the preferred inverted and downwardly-angled orientation described herein without any substantial physical contact between the exterior surface of the poultry 12 and the pan 18, pan insert 20, free-standing base 90 or any other cooking surface, and with the poultry support 40 in physical contact only with the interior of the poultry 12.

In each of the example embodiments, the poultry support 40 comprises a first end portion 42 and a second end portion 44. The poultry support further comprises a first member 50, a second member 60, a third member 70, and a fourth member 80 arranged between the first and second end portions 42, 44. The members 50, 60, 70, and 80 may comprise a single structure, such as a single elongated rod, or one or more of the members 50, 60, 70, 80 may comprise separate structures, e.g., separate elongated rods, and the structures may be interconnected in a suitable fashion to form the poultry support 40 structure.

Similarly, each one of the first member 50, the second member 60, the third member 70, and the fourth member 80 may comprise a single structure or may comprise two or more corresponding and/or interconnected structures. In the example embodiment illustrated in FIGS. 1-6 for example, the first member 50, the second member 60, the third member 70, and the fourth member 80 each comprise a single structure, preferably a single rod. Alternatively, in the example embodiments illustrated in FIGS. 7-15 for example, the first member 50, the second member 60, the third member 70, and the fourth member 80 each comprise two or more corresponding and cooperating structures, which preferably comprise at least two corresponding rods or two corresponding portions of a single rod. Preferably when two or more corresponding and cooperating structures or portions of a structure are employed, they comprise two or more substantially parallel and co-extensive structures or portions of a structure, i.e., structures or portions of a structure with respective first ends and second ends that terminate at substantially the same extents, as illustrated for example in FIGS. 7, 8A, 11A, and 13.

### H. First Member.

The first member 50 comprises an elongated substantially linear structure having a first end portion 52 and a second end portion 54 opposite the first end portion 52. The first end portion 52 of the first member 50 corresponds with the first end portion 42 of the poultry support 40. The first member 50 extends from the first end portion 42 of the poultry support 40 for a finite distance and terminates at the second end portion 54. The first member 50 is configured and adapted to be slidably receivable and insertable in and removable from the one or more receivers 32 of the base 30 and to be selectively retained in the one or more receivers 32 of the base 30 as described above. The first member 50 is further adapted and configured to be slidably receivable and insertable and to be retained in the one or more receivers 32 of the base 30 substantially parallel to the upper surface 19 of the pan 18, the upper surface 22 of the pan insert 20, or the upper surface 92 of the free-standing base structure 90 in the respective example embodiments. Accordingly, in an embodiment in which the upper surface 19, 22, or 92 is substantially horizontal, the first member 50 will be slidably inserted and retained in the one or more receivers 32 substantially horizontally.

### I. Second Member.

The second member 60 comprises an elongated substantially linear structure having a first end portion 62 and a second end portion 64 opposite the first end portion 62. The first end portion 62 of the second member 60 is connected to or transitions into the second end portion 54 of the first member 50. The second member 60 extends from the second end portion 54 of the first member 50 for a finite distance and terminates at the second end portion 64.

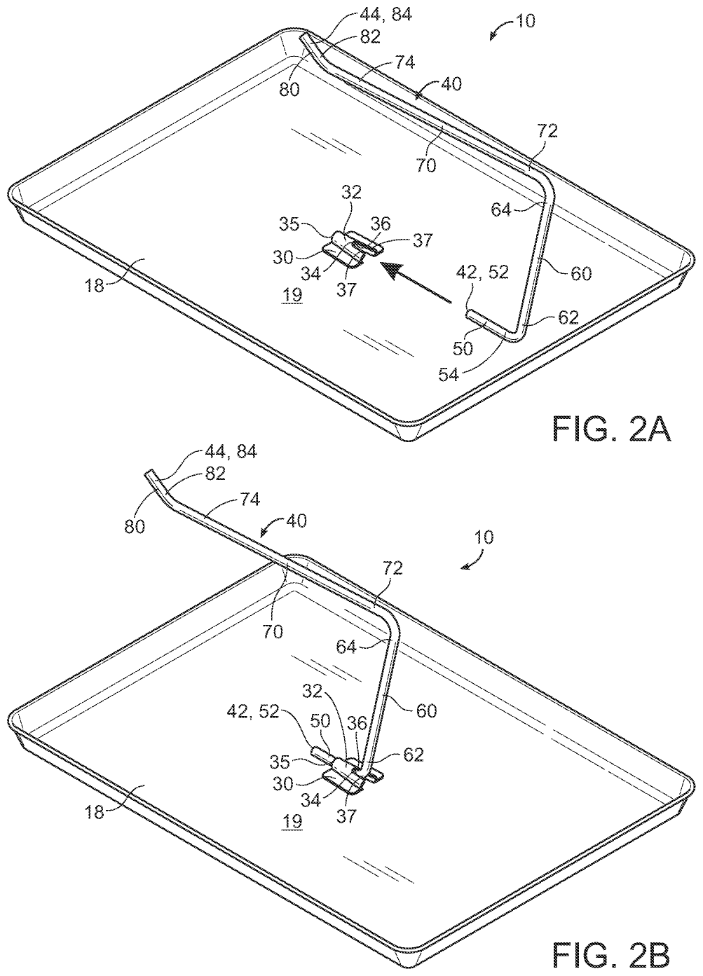

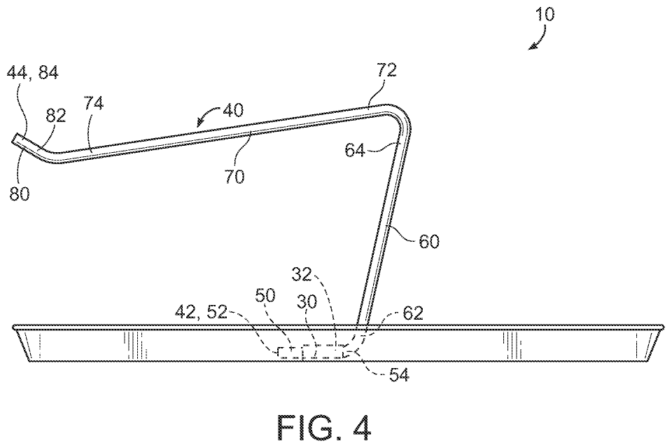

In one example embodiment illustrated in FIGS. 1-6, the second member 60 extends upwardly from the second end portion 54 of the first member 50 at a first angle with respect to the upper surface 19 of the pan 18 as best illustrated in FIGS. 2B and 4. In this embodiment, the base 30 is located near the middle of the upper surface 19 of the pan 18. The second member 60 extends away from the first member 50, away from the base 30, and toward an outer end or edge of the pan 18 with the second end 64 located above the upper surface 19. This provides space for the third member 70 described below to be arranged to support and suspend the poultry 12 over the pan 18.

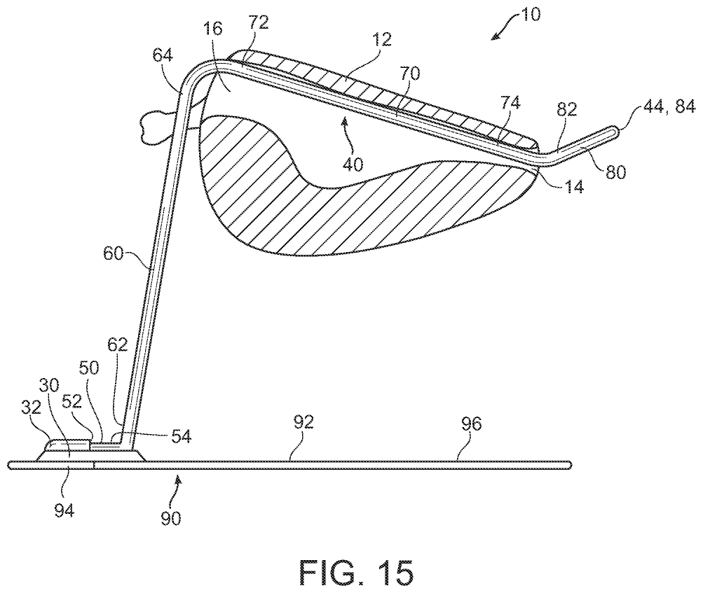

In other example embodiments illustrated in FIGS. 7-12 and 13-15, the second member 60 also extends upwardly from the second end portion 54 of the first member 50 at a first angle with respect to the upper surface 22 of the pan insert 20 as best illustrated in FIGS. 7, 8B, and 10 or the upper surface 92 of the free-standing base structure 90 as best illustrated in FIGS. 13 and 15. However, in these example embodiments, the base 30 is located nearer an outer edge of the pan insert 20 or on the common connection area 94 of the free-standing base structure 90 near the first end of the elongated extensions 96. In these example embodiments, the first angle is greater than the first angle in the example embodiment illustrated in FIGS. 1-6. In addition, in these example embodiments the second member 60 extends away from the first member 50 and away from the base 30, but toward the middle of the pan insert 20, or between and toward the second ends of the extensions 96, with the second end portion 64 located above the base 30 or the upper surface 22 of the pan insert 20, or above the base 30 or the open space between the extensions 96. This configuration provides space for the third member 70 described below to be arranged to support and suspend the poultry 12 over the pan insert 20 or over the open space between the extensions 96.

### J. Third Member.

The third member 70 comprises an elongated substantially linear structure having a first end portion 72 and a second end portion 74 opposite the first end portion 72. The first end portion 72 of the third member 70 is connected to or transitions into the second end portion 64 of the second member 60. The third member 70 extends from the second end portion 64 of the second member 60 for a finite distance and terminates at the second end portion 74.

The third member 70 extends downwardly from the second end portion 64 of the second member 60 at a second angle with respect to the upper surface 19 of the pan 18 as best illustrated in FIGS. 2B and 4, at a second angle with respect to the upper surface 22 of the pan insert 20 as best illustrated in FIGS. 7, 8B, and 12, and at a second angle with respect to the upper surface 92 of the free-standing base structure 90 as best illustrated in FIGS. 13 and 15. The second angle is preferably less than the first angle. For example, depending on the relative lengths of the second and third members 60, 70, the size of the poultry 12, and the dimensions of the pan 18, the first angle in the example embodiments of FIGS. 1-6 may be in the range of approximately 45-60 degrees and in the example embodiments of FIGS. 7-12 and 13-15 in the range of approximately 60-80 degrees. In each of the example embodiments, the second angle may be in the range of approximately 10-25 degrees.

The third member 70 is configured and adapted to extend through the rear opening 16 and the neck opening 14 of the poultry 12 to support the poultry 12 in the preferred inverted and downwardly-angled orientation for cooking as illustrated in FIGS. 6, 12, and 15. The preferred inverted and downwardly-angled orientation for the poultry 12 is comprised of a breast portion of the poultry 12 being the lowest portion of the poultry 12 when positioned upon the third member 70. With the breast portion lower than the legs, the legs and breast portion are allowed to cook evenly within the oven. In addition, since the third member 70 extends through the interior of the poultry 12, there is little, if any, physical contact with the exterior surface of the poultry 12 allowing the exterior surface to cook evenly and in a crispy manner.

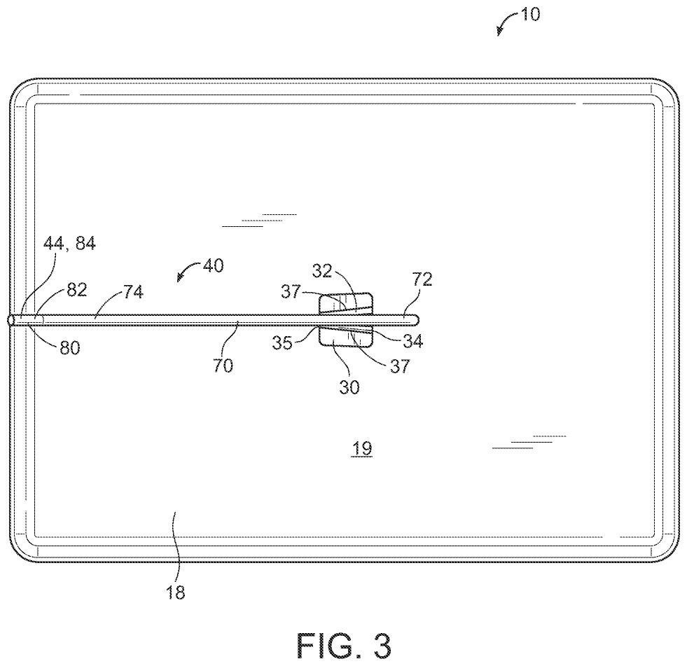

As best illustrated in FIGS. 1, 2B, 4, 6, 7, 8B, 10, 12, 13, and 15, the third member 70 is preferably positioned above the first and second members 50, 60, the base 30, and the upper surfaces 19, 22, and 92 of the pan 18, pan insert 20, and free-standing base structure 90 respectively. In the example embodiment of FIGS. 13-15, the third member 70 is also positioned above the open space between the extensions 96 of the free-standing base structure 90. In each of the example embodiments, the third member 70 also preferably extends past the base unit 30 a finite distance as illustrated in FIGS. 2B, 4, 7, 10, 14, and others. Also as shown in FIGS. 3, 9, 14, and others, the first member 50, the second member 60, and the third member 70 are preferably arranged substantially along a common vertical plane with respect to one another and are arranged and spaced apart sufficiently to allow for the poultry 12 to be received, supported, and suspended on the third member 70 without the first member 50 or the second member 60 touching the poultry 12. Similarly, the first member 50, second member 60, and third member 70 are preferably arranged and spaced apart so that the pan 18, pan insert 20, and free-standing base structure 90 do not touch the poultry 12 while it is supported and suspended on the third member 70.

### K. Fourth Member.

The fourth member 80 comprises an elongated substantially linear structure having a first end portion 82 and a second end portion 84 opposite the first end portion 82. The first end portion 82 of the fourth member 80 is connected to or transitions into the second end portion 74 of the third member 70. The fourth member 80 extends from the second end portion 74 of the third member 70 for a finite distance and terminates at the second end portion 84. The second end portion 84 corresponds with the second end portion 44 of the poultry support 40.

The second end portion 84 may have an open configuration as illustrated in FIG. 1 for example, or a closed configuration as illustrated in FIGS. 7 and 13 for example. The second end portions 84 of two or more corresponding and cooperating structures comprising the fourth member 80 may be interconnected or may transition or merge together to form the closed configuration.

The fourth member 80 comprises a retention structure, which may comprise a “hook” of sorts. The fourth member 80 retention structure is configured and adapted to engage the poultry 12 and to retain it on the third member 70 in the preferred inverted and downwardly-angled orientation so that it cannot slide off for example. For that purpose, the fourth member 80 preferably extends upwardly from the first end portion 82 to the second end portion 84 at a third angle with respect to the upper surface of the pan 18, pan insert 20, and free-standing base structure 90 so as to engage an upper edge of the neck opening 14 when the poultry 12 is supported and suspended on the third member 70. The third angle may be in the range of approximately 10-30 degrees.

In particular example embodiments, the first member 50, second member 60, third member 70, and fourth member 80 are preferably comprised of a single elongated metal rod which is easy to manufacture and easy to clean. It is preferable that the single elongated metal rod is comprised of ¼ inch metal rod. In the example embodiment illustrated in FIGS. 1-6 wherein the members comprise a single structure, the overall length of the metal rod is approximately 20 inches. In the example embodiments illustrated in FIGS. 7-12 and 13-15 wherein the members each comprise two portions of the metal rod formed in parallel, the overall length of the metal rod is approximately 40 inches. In the example embodiment of FIGS. 1-6, the first member 50 is preferably approximately 2 inches in length, the second member 60 is preferably approximately 8 inches in length, the third member 70 is preferably approximately 9.5 inches in length, and the fourth member 80 is preferably approximately 1.5 inches in length. In the example embodiments of FIGS. 7-12 and 13-15, the first member 50 is preferably approximately 2 inches in length, the second member 60 is preferably approximately 8 inches in length, the third member 70 is preferably approximately 8.5 inches in length, and the fourth member 80 is preferably approximately 1.5 inches in length. In each of the example embodiments, the first member 50, second member 60, third member 70, and fourth member 80 are preferably aligned substantially along a common vertical plane as illustrated in FIGS. 3, 9, and 14.

### L. Operation of Preferred Embodiments.

In use, a user positions the poultry 12 on the poultry support 40 by extending the third member 70 of the poultry support 40 through the rear opening 16 of the poultry 12 and out through the neck opening 14 of the poultry 12. The user positions the poultry 12 so that the poultry is inverted with the breast portion hanging downwardly in the lowest position as illustrated in FIGS. 6, 12, and 15. The user may position the poultry 12 on the poultry support 40 before or after connecting or attaching the poultry support 40 to the base 30 on the pan 18, pan insert 20, or free-standing base structure 90 as described herein, however in many instances it may generally be easier to attach or connect the poultry support 40 to the base 30 before positioning the poultry 12 on the poultry support 40.

If using the example embodiment of FIGS. 1-6, the user may then position the pan 18 with the inverted suspension poultry roasting rack 10 and poultry 12 directly in the oven on a rack or the like. If using the example embodiment of FIG. 7-12 or 13-15, the user may position the pan insert 20 or free-standing base 90 of the inverted suspension poultry roasting rack 10 with the poultry 12 in or on the pan 18 or other drip collection item and then position the pan 18 or other drip collection item in the oven on a rack or the like. Alternatively, the user may position the pan insert 20 or free-standing base 90 of the inverted suspension poultry roasting rack 10 with the poultry 12 directly in the oven on a rack or the like.

During cooking, the leg meat of the poultry 12 is cooked evenly with the breast meat because the leg meat is higher in the oven than the breast. In addition, because of the downward angle of the third member 70 supporting and suspending the poultry 12 in a similar downward angle, the juices released from the poultry 12 during cooking are collected in the interior breast portion of the poultry 12 thereby maintaining moisture and enhancing the flavor of the breast meat. Furthermore, because no physical contact is made with the exterior of the poultry 12, the poultry 12 cooks more evenly as the hot air contacts every exterior surface of the poultry 12 during cooking resulting in an evenly crispy skin. After the poultry 12 is fully cooked, the user removes the cooked poultry 12 from the third member 70 by raising it upwardly over the retention structure or “hook” of the fourth member 80. If the example embodiment of FIGS. 7-12 is being used, the user can elect to use the pan insert 20 as a surface for carving and otherwise preparing the poultry 12 before it is served.

Unless otherwise defined, all technical and scientific terms used herein have the same meaning as commonly understood by one of ordinary skill in the art to which this invention belongs. Although methods and materials similar to or equivalent to those described herein can be used in the practice or testing of the inverted suspension poultry roasting rack, suitable methods and materials are described above. All publications, patent applications, patents, and other references mentioned herein are incorporated by reference in their entirety to the extent allowed by applicable law and regulations. The inverted suspension poultry roasting rack may be embodied in other specific forms without departing from the spirit or essential attributes thereof, and it is therefore desired that the present embodiment be considered in all respects as illustrative and not restrictive. For example, features, characteristics and structures of the various example embodiments described herein may be combined in various ways to obtain additional embodiments without departing from the spirit or essential attributes of the example embodiments presented. Any headings utilized within the description are for convenience only and have no legal or limiting effect.

What is claimed is:

1. An inverted suspension poultry roasting rack system, comprising:
a pan with a surface;
a base connected to the pan surface; and
a poultry support removably connectable to the base, wherein the poultry support is adapted to support and suspend a poultry having an interior and an exterior in an inverted and downwardly-angled orientation above the pan surface for cooking with the poultry support having substantial physical contact only with the interior of the poultry.

2. The inverted suspension poultry roasting rack system of claim 1, wherein the base is permanently and non-movably connected to the pan surface.

3. The inverted suspension poultry roasting rack system of claim 1, wherein the base comprises a receiver adapted to slidably receive and retain the poultry support.

4. The inverted suspension poultry roasting rack system of claim 1, wherein the base comprises an anti-rotation mechanism adapted to engage the poultry support and prevent it from rotatably moving relative to the base.

5. The inverted suspension poultry roasting rack system of claim 1, wherein the poultry support is comprised of a single elongated metal rod.

6. The inverted suspension poultry roasting rack system of claim 1, wherein the poultry support comprises a first member removably connectable to the base, a second member extending upwardly from the first member at a first angle with respect to the pan surface, a third member extending downwardly from the second member at a second angle with respect to the pan surface, and a fourth member extending upwardly from the third member at a third angle with respect to the pan surface;
wherein the third member is adapted to support and suspend the poultry; and
wherein the fourth member is adapted to prevent the poultry from sliding off the third member.

7. The inverted suspension poultry roasting rack system of claim 6, wherein the base comprises a receiver adapted to receive and retain the first member substantially parallel to the pan.

8. The inverted suspension poultry roasting rack system of claim 6, wherein the first member, the second member, the third member, and the fourth member are comprised of a single elongated metal rod.

9. The inverted suspension poultry roasting rack system of claim 6, wherein the first member, the second member, the third member, and the fourth member are substantially aligned along a common vertical plane.

10. The inverted suspension poultry roasting rack system of claim 6, wherein the first angle is greater than the second angle.

11. An inverted suspension poultry roasting rack system, comprising:
a pan with a first surface;
a pan insert with a second surface and a third surface opposite the second surface;
wherein the pan insert is adapted to be removably received and supported in or on the pan with the second surface adjacent to the first surface;
a base connected to the third surface; and
a poultry support comprising a first member adapted to be removably connected to the base, a second member extending upwardly from the first member at a first angle with respect to the third surface, a third member extending downwardly from the second member at a second angle with respect to the third surface, and a fourth member extending upwardly from the third member at a third angle with respect to the third surface;
wherein the third member is adapted to support and suspend a poultry having an interior and an exterior in an inverted and downwardly-angled orientation above the third surface for cooking with the poultry support having substantial physical contact only with the interior of the poultry.

12. The inverted suspension poultry roasting rack system of claim 11, wherein the base is permanently and non-movably connected to the third surface.

13. The inverted suspension poultry roasting rack of claim 11, wherein the base comprises a receiver adapted to slidably receive and retain the first member.

14. The inverted suspension poultry roasting rack of claim 11, wherein the base comprises an anti-rotation mechanism adapted to engage the poultry support and prevent it from rotatably moving relative to the base.

15. The inverted suspension poultry roasting rack system of claim 11, wherein the poultry support is comprised of a single elongated metal rod.

16. The inverted suspension poultry roasting rack system of claim 11, wherein at least one of the first member, the second member, the third member, and the fourth member is comprised of a plurality of parallel elongated rod structures.

17. The inverted suspension poultry roasting rack system of claim 11, wherein the first member, the second member, the third member, and the fourth member are substantially aligned along a common vertical plane.

18. The inverted suspension poultry roasting rack system of claim 11, wherein the first angle is greater than the second angle.

19. An inverted suspension poultry roasting rack system, comprising:
a free-standing base structure with a surface, a common connection area, a plurality of elongated extensions extending from the common connection area, and an open space between the extensions;
a base permanently and non-movably connected to the surface on the common connection area; and
a poultry support comprising a first member adapted to be removably connected to the base, a second member extending upwardly from the first member at a first angle with respect to the surface, a third member extending downwardly from the second member at a second angle with respect to the surface, and a fourth member extending upwardly from the third member at a third angle with respect to the surface;
wherein the third member is adapted to support and suspend a poultry having an interior and an exterior in an inverted and downwardly-angled orientation above the open space for cooking with the poultry support having substantial physical contact only with the interior of the poultry.

20. The inverted suspension poultry roasting rack system of claim 19, wherein the base is permanently and non-movably connected to the surface.
